(19) United States
(12) Patent Application Publication
(10) Pub. No.: US 2011/0059362 A1
(43) Pub. Date: Mar. 10, 2011

(54) METHODS FOR FORMING FOAMED ELECTRODE STRUCTURES

(75) Inventors: Jon K. West, Gainesville, FL (US); Julius Regalado, Gainesville, FL (US); Xin Zhou, Gainesville, FL (US); Nelson Citta, Lake City, FL (US)

(73) Assignee: G4 SYNERGETICS, INC., Roslyn, NY (US)

(21) Appl. No.: 12/875,490

(22) Filed: Sep. 3, 2010

Related U.S. Application Data
(60) Provisional application No. 61/239,910, filed on Sep. 4, 2009.

(51) Int. Cl. H01M 4/38; H01M 4/02; H01M 4/04; B05D 5/12

(52) U.S. Cl. 429/219; 429/209; 429/218.1; 429/220; 429/223; 427/77

(57) ABSTRACT

Electrode structures may include an electronically conductive foam in contact with an electronically conductive substrate. In some embodiments, the foam may be formed by coating a porous precursor material in contact with a substrate with an electronically conductive material and subsequently removing the precursor material. In some embodiments, the foam may be formed by removing a non-conductive component of a composite material in contact with a substrate, leaving a conductive component in contact with the substrate. Electrode structures may be coated with electronically conductive materials or sintered at elevated temperature to improve durability and conductivity.

### CROSS-REFERENCE TO RELATED APPLICATION

This application claims the benefit of U.S. Provisional Application No. 61/239,910, filed Sep. 4, 2009, which is hereby incorporated by reference herein in its entirety.

### FIELD OF THE INVENTION

The present invention relates to forming electrodes, and more particularly to processing techniques for creating electrode structures containing an electronically conductive foam and an electronically conductive substrate.

### BACKGROUND OF THE INVENTION

Electrodes are used to supply and remove electrons from some medium, and are typically manufactured from metals or metal alloys. Electrochemical cells use electrodes to facilitate electron transport and transfer during electrochemical interactions. Batteries, or electrochemical storage devices, may use electrodes in both galvanic and electrolytic capacities, corresponding to discharging or charging processes, respectively. Electrochemical reactions generally occur at or near the interfaces of an electrolyte and the electrodes, which may extend to an external circuit through which electric power can be applied or extracted.

Electrodes are typically placed in contact with current collectors in order to draw and/or supply electrical power. In order to reduce system losses, there must be sufficient electrical contact at the interface between the electrode and the current collector. The quality of this interface may depend on the processing steps used to manufacture the electrode and the current collector, and the assembly steps used to place the two components in electrical contact.

Numerous processing steps, which include both mechanical and chemical interactions, are typically required to manufacture the electrodes and current collectors that accomplish the aforementioned assembly. These numerous processing steps, often using multiple subassemblies, may increase cost, increase infrastructure requirements, and introduce opportunities for manufacturing errors to occur. Accordingly, it would be desirable to reduce and/or consolidate the processing steps required to manufacture electrode structures.

### SUMMARY OF THE INVENTION

In view of the foregoing, provided are techniques, compositions, and arrangements for forming electrode structures that include one or more electronically conductive foams in contact with one or more electronically conductive substrates. In some embodiments the present invention provides techniques for forming electronically conductive foams directly on an electronically conductive substrate. In some approaches, forming electronically conductive foams directly on an electronically conductive substrate may reduce, consolidate, or both, the process steps for forming electrode structures.

In some embodiments, a precursor material may be placed in contact with an electronically conductive substrate (e.g., metal), where an interface may exist between a surface of the substrate and the precursor material. The precursor material may be a polymer foam, polymer slurry, dried polymer slurry, any other suitable precursor material or any suitable combination thereof. In some embodiments, the precursor material in contact with the substrate may be further processed (e.g., dried, cured) while in contact with the substrate. For example, a plating or coating process may be applied to the subassembly of the precursor material and substrate in contact with one another. The plating or coating process may include coating all or part of the precursor material and substrate with an electronically conductive material (e.g., metal) to form an electronically conductive network throughout the volume of the precursor material. The plated precursor material, as well as one or more components of the plated precursor material, may be substantially removed (e.g., pyrolyzed), thereby leaving an electronically conductive foam in contact with the substrate. In some embodiments, active materials may be included in the precursor material, or the active materials may be introduced to the electronically conductive foam, or both. In some embodiments, the electronically conductive foam may be sintered at elevated temperature. The substrate and foam may be of any suitable shape, including flat plate, curved plate, dome, or any other suitable shape or combination thereof.

In some embodiments, a plurality of first particles may be combined with a plurality of second particles and a liquid agent to form a slurry. The slurry may include at least one electronically conductive component and at least one electronically nonconductive component including, but not limited to, one or more of polymer particles, binders, liquid agents, any other suitable electronically nonconductive material or any suitable combination thereof. At least one contiguous layer of the slurry may be formed on a surface of an electronically conductive substrate. The layers may be uniform or non-uniform in thickness and may be contiguous or non-contiguous on the surface of the substrate. In some embodiments, more than one contiguous layer may be formed on a surface of the substrate.

Substantially all (i.e., all or almost all) of the liquid agent may be removed from the at least one contiguous layer of the slurry to leave a solid composite material, where the solid composite material may remain in contact with the surface of the substrate. For example, the liquid agent may be removed by drying, heating, any other suitable removal process, or any combination thereof. Substantially all of the plurality of first particles may be removed from the composite material (e.g., pyrolyzed), where the remaining plurality of second particles may form a corresponding electronically conductive foam in contact with the substrate.

In some embodiments, a composite material may be placed in contact with an electronically conductive substrate. The composite material may include at least one electronically conductive component and at least one electronically nonconductive component including, but not limited to, one or more of a polymer foam, dried polymer slurry, any other suitable electronically nonconductive material or any suitable combination thereof. The composite material may be a composite slurry including two or more types of particles. For example, the composite material may be a slurry including a liquid agent (e.g., organic solvent), electronically conductive particles (e.g., metal) and electronically nonconductive particles (e.g., polymer). In some embodiments, the composite slurry may be further processed (e.g., dried, cured) while in contact with the substrate. The electronically nonconductive components, or any other components, may be substantially removed (e.g., pyrolyzed) from the dried composite slurry, thereby leaving an electronically conductive foam in contact with the substrate.

### BRIEF DESCRIPTION OF THE DRAWINGS

FIG. 1 shows a schematic cross-sectional view of an illustrative structure of a bi-polar electrode-unit (BPU) in accordance with some embodiments of the present invention;

FIG. 2 shows a schematic cross-sectional view of an illustrative structure of a stack of BPUs of FIG. 1 in accordance with some embodiments of the present invention;

FIG. 3 shows a schematic cross-sectional view of an illustrative structure of a mono-polar electrode-unit (MPU) in accordance with some embodiments of the present invention;

FIG. 4 shows a schematic cross-sectional view of an illustrative structure of a device containing two MPUs of FIG. 3 in accordance with some embodiments of the present invention;

FIG. 5 shows a cubic section of an illustrative solid-phase foam in accordance with some embodiments of the present invention;

FIG. 6 shows an illustrative electrode structure with a cutaway section in accordance with some embodiments of the present invention;

FIG. 7 shows an illustrative flow diagram for creating an electrode structure in accordance with some embodiments of the present invention;

FIG. 8 shows an illustrative flow diagram for creating an electrode structure in accordance with some embodiments of the present invention;

FIG. 9 shows an illustrative flow diagram for creating an electrode structure in accordance with some embodiments of the present invention;

FIG. 10 shows an illustrative flow diagram for creating an electrode structure in accordance with some embodiments of the present invention;

FIG. 11 shows an illustrative side elevation view of a precursor material in contact with a substrate in accordance with some embodiments of the present invention;

FIG. 12 shows an illustrative top plan view of the elements of FIG. 11, taken from line XII-XII, in accordance with some embodiments of the present invention;

FIG. 13 shows an illustrative partial cross-sectional view of an interface between a precursor material and a substrate in accordance with some embodiments of the present invention;

FIG. 14 shows an illustrative partial cross-sectional view of the interface of FIG. 13, coated with an electronically conductive material in accordance with some embodiments of the present invention;

FIG. 15 shows an illustrative partial cross-sectional view of the interface of FIG. 14 in accordance with some embodiments of the present invention;

FIG. 16 shows an illustrative side elevation view of a composite material in contact with a substrate in accordance with some embodiments of the present invention;

FIG. 17 shows an illustrative top plan view of the elements of FIG. 16, taken from line XVII-XVII, in accordance with some embodiments of the present invention;

FIG. 18 shows an illustrative partial cross-sectional view of an interface between a composite material and a substrate in accordance with some embodiments of the present invention;

FIG. 19 shows an illustrative partial cross-sectional view of an interface between an electronically conductive foam and a substrate in accordance with some embodiments of the present invention;

FIG. 20 shows an illustrative partial cross-sectional view of an interface between a composite material and a substrate in accordance with some embodiments of the present invention; and

FIG. 21 shows an illustrative partial cross-sectional view of an interface between an electronically conductive foam and a substrate in accordance with some embodiments of the present invention.

### DETAILED DESCRIPTION OF THE INVENTION

The present invention provides methods, compositions, and arrangements for forming electrode structures that include one or more electronically conductive foams in contact with one or more electronically conductive substrates. The present invention provides methods, compositions, and arrangements for forming electronically conductive foams directly on an electronically conductive substrate. The electrode structures and assemblies of the present invention may be applied to energy storage devices such as, for example, batteries, capacitors or any other energy storage device which may store or provide electrical energy or current, or any combination thereof. For example, the electrode structures and assemblies of the present invention may be implemented in a mono-polar electrode unit (MPU) or a bi-polar electrode unit (BPU), and may be applied to one or more surfaces of the MPU or BPU. It will be understood that while the present invention is described herein in the context of stacked energy storage devices, the concepts discussed are applicable to any intercellular electrode configuration including, but not limited to, parallel plate, prismatic, folded, wound and/or bipolar configurations, any other suitable configurations or any combinations thereof.

In some embodiments, electrodes may contain porous structures or conductive foams to increase interface area, which may improve transport of compounds such as molecules (e.g., water) or ions (e.g., hydroxyl ions), or both. Electrochemical reactions may occur at or near interfaces between an active material, an electrolyte and an electronically conducting component. Increased interface area may allow increased charge or discharge rates for electrochemical devices. In some embodiments, the disclosed techniques, compositions, and arrangements may provide electrodes having porous structures or conductive foams in contact with suitable substrates.

The present disclosure includes methods, compositions, and arrangements for forming electronically conductive electrodes in contact with electronically conductive substrates. The electrode may be formed, for example, by coating a porous precursor material with electronically conductive material, or removing one or more components of a solid composite material, or both. In some embodiments, electronically conductive networks or foams may be formed directly on one or more surfaces of a substrate.

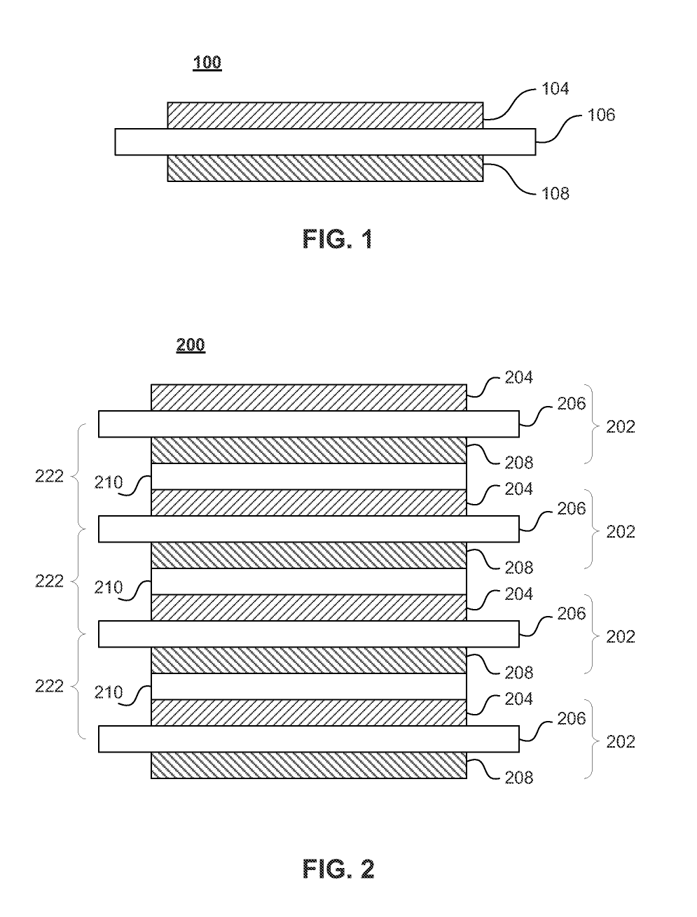

The invention will now be described in the context of FIGS. 1-21, which show illustrative embodiments.

FIG. 1 shows a schematic cross-sectional view of an illustrative structure of BPU 100 in accordance with some embodiments of the present invention. Exemplary BPU 100 may include a positive active material electrode layer 104, an electronically conductive, impermeable substrate 106, and a negative active material electrode layer 108. Positive electrode layer 104 and negative electrode layer 108 are provided on opposite sides of substrate 106.

FIG. 2 shows a schematic cross-sectional view of an illustrative structure of stack 200 of BPUs 100 of FIG. 1 in accordance with some embodiments of the present invention. Multiple BPUs 202 may be arranged into stack configuration 200. Within stack 200, electrolyte layer 210 is provided between two adjacent BPUs, such that positive electrode layer 204 of one BPU is opposed to negative electrode layer 208 of an adjacent BPU, with electrolyte layer 210 positioned between the BPUs. A separator may be provided in one or more electrolyte layers 210 to electrically separate opposing positive and negative electrode layers. The separator allows ionic transfer between the adjacent electrode units for recombination, but may substantially prevent electronic transfer between the adjacent electrode units. As defined herein, a “cell” or “cell segment” 222 refers to the components included in substrate 206 and positive electrode layer 204 of a first BPU 202, negative electrode layer 208 and substrate 206 of a second BPU 202 adjacent to the first BPU 202, and electrolyte layer 210 between the first and second BPUs 202. Each impermeable substrate 206 of each cell segment 222 may be shared by applicable adjacent cell segment 222.

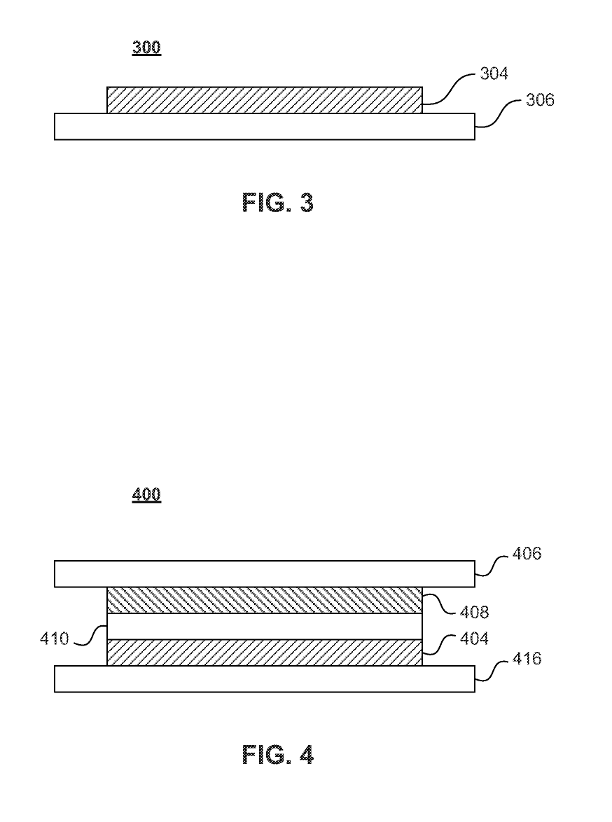

FIG. 3 shows a schematic cross-sectional view of an illustrative structure of MPU 300 in accordance with some embodiments of the present invention. Exemplary MPU 300 may include active material electrode layer 304 and electronically conductive, impermeable substrate 306. Active material layer 304 may be any suitable positive or negative active material.

FIG. 4 shows a schematic cross-sectional view of an illustrative structure of a device containing two MPUs of FIG. 3 in accordance with some embodiments of the present invention. Two MPUs 300 having a positive and negative active material, respectively, may be stacked to form electrochemical device 400. Electrolyte layer 410 may be provided between two MPUs 300, such that positive electrode layer 404 of one MPU 300 is opposed to negative electrode layer 408 of the other MPU 300, with electrolyte layer 410 positioned between the MPUs. A separator may be provided electrolyte layers 410 to electrically separate opposing positive and negative electrode layers. Although not shown, in some embodiments two MPUs having positive and negative active material, respectively, may be added to stack 200, along with suitable layers of electrolyte, to form a bi-polar battery. Bi-polar batteries and battery stacks are discussed in more detail in Ogg et al. U.S. patent application Ser. No. 11/417,489, Ogg et al. U.S. patent application Ser. No. 12/069,793, and West et al. U.S. patent application Ser. No. 12/258,854, all of which are hereby incorporated by reference herein in their entireties.

The substrates used to form electrode units (e.g., substrate 106, 206, 406, 416) may be formed of any suitable electronically conductive and impermeable or substantially impermeable material, including, but not limited to, a non-perforated metal foil, aluminum foil, stainless steel foil, cladding material including nickel and aluminum, cladding material including copper and aluminum, nickel plated steel, nickel plated copper, nickel plated aluminum, gold, silver, any other suitable electronically conductive and impermeable material or any suitable combinations thereof. In some embodiments, substrates may be formed of one or more suitable metals or combination of metals (e.g., alloys, solid solutions, plated metals). Each substrate may be made of two or more sheets of metal foils adhered to one another, in certain embodiments. The substrate of each BPU may typically be between 0.025 and 5 millimeters thick, while the substrate of each MPU may be between 0.025 and 30 millimeters thick and act as terminals or sub-terminals to the ESD, for example. Metalized foam, for example, may be combined with any suitable substrate material in a flat metal film or foil, for example, such that resistance between active materials of a cell segment may be reduced by expanding the conductive matrix throughout the electrode.

The positive electrode layers provided on these substrates to form the electrode units of the invention (e.g., positive electrode layers 104, 204 and 404) may be formed of any suitable active material, including, but not limited to, nickel hydroxide (Ni(OH)₂), zinc (Zn), any other suitable material, or combinations thereof, for example. The positive active material may be sintered and impregnated, coated with an aqueous binder and pressed, coated with an organic binder and pressed, or contained by any other suitable technique for containing the positive active material with other supporting chemicals in a conductive matrix. The positive electrode layer of the electrode unit may have particles, including, but not limited to, metal hydride (MH), palladium (Pd), silver (Ag), any other suitable material, or combinations thereof, infused in its matrix to reduce swelling, for example. This may increase cycle life, improve recombination, and reduce pressure within the cell segment, for example. These particles, such as MH, may also be in a bonding of the active material paste, such as Ni(OH)₂, to improve the electrical conductivity within the electrode and to support recombination.

The negative electrode layers provided on these substrates to form the electrode units of the invention (e.g., negative electrode layers 108, 208, and 408) may be formed of any suitable active material, including, but not limited to, MH, cadmium (Cd), manganese (Mn), Ag, any other suitable material, or combinations thereof, for example. The negative active material may be sintered, coated with an aqueous binder and pressed, coated with an organic binder and pressed, or contained by any other suitable technique for containing the negative active material with other supporting chemicals in a conductive matrix, for example. The negative electrode side may have chemicals including, but not limited to, Ni, Zn, Al, any other suitable material, or combinations thereof, infused within the negative electrode material matrix to stabilize the structure, reduce oxidation, and extend cycle life, for example.

Various suitable binders, including, but not limited to, organic carboxymethylcellulose (CMC), Creyton rubber, PTFE (Teflon), any other suitable material or any suitable combinations thereof, for example, may be mixed with or otherwise introduced to the active material to maintain contact between the active material and a substrate, solid-phase foam, any other suitable component, or any suitable combination thereof. Any suitable binders may be included in slurries or any other mixtures to increase adherence, cohesion or other suitable property or combination thereof.

The separator of each electrolyte layer of an ESD may be formed of any suitable material that electrically isolates its two adjacent electrode units while allowing ionic transfer between those electrode units. The separator may contain cellulose super absorbers to improve filling and act as an electrolyte reservoir to increase cycle life, wherein the separator may be made of a polyabsorb diaper material, for example. The separator may, thereby, release previously absorbed electrolyte when charge is applied to the ESD. In certain embodiments, the separator may be of a lower density and thicker than normal cells so that the inter-electrode spacing (IES) may start higher than normal and be continually reduced to maintain the capacity (or C-rate) of the ESD over its life as well as to extend the life of the ESD.

The separator may be a relatively thin material bonded to the surface of the active material on the electrode units to reduce shorting and improve recombination. This separator material may be sprayed on, coated on, pressed on, or combinations thereof, for example. The separator may have a recombination agent attached thereto. This agent may be infused within the structure of the separator (e.g., this may be done by physically trapping the agent in a wet process using a polyvinyl alcohol (PVA or PVOH) to bind the agent to the separator fibers, or the agent may be put therein by electro-deposition), or it may be layered on the surface by vapor deposition, for example. The separator may be made of any suitable material such as, for example, polypropylene, polyethylene, any other suitable material or any combinations thereof. The separator may include an agent that effectively supports recombination, including, but not limited to, lead (Pb), Ag, platinum (Pt), Pd, any other suitable material, or any suitable combinations thereof, for example. In some embodiments, an agent may be substantially insulated from (e.g., not contact) any electronically conductive component or material. For example, in some arrangements the agent may be positioned between sheets of the separator material such that the agent does not contact electronically conductive electrodes or substrates. While the separator may present a resistance if the substrates of a cell move toward each other, a separator may not be provided in certain embodiments of the invention that may utilize substrates stiff enough not to deflect.

The electrolyte of each electrolyte layer of an ESD may be formed of any suitable chemical compound that may ionize when dissolved or molten to produce an electrically conductive medium. The electrolyte may be a standard electrolyte of any suitable ESD, including, but not limited to, NiMH, for example. The electrolyte may contain additional chemicals, including, but not limited to, lithium hydroxide (LiOH), sodium hydroxide (NaOH), calcium hydroxide (CaOH), potassium hydroxide (KOH), any other suitable material, or combinations thereof, for example. The electrolyte may also contain additives to improve recombination, including, but not limited to, Ag(OH)₂, for example. The electrolyte may also contain rubidium hydroxide (RbOH), for example, to improve low temperature performance. The electrolyte may be frozen within the separator and then thawed after the ESD is completely assembled. This may allow for particularly viscous electrolytes to be inserted into the electrode unit stack of the ESD before the gaskets have formed substantially fluid tight seals with the electrode units adjacent thereto.

Electrodes may contain an electronically conductive network or component. The electronically conductive network or component may reduce ohmic resistance and may allow increased interface area for electrochemical interactions. For example, in stack 400 shown in FIG. 4, the interface between electrolyte 410 and either positive electrode layer 404 or negative electrode layer 408 appears to be a planar, two dimensional surface. While a planar interface may be employed in some embodiments of energy storage devices, the electrode may also have porous structure. The porous structure may increase the interface area between electrode and electrolyte, which may increase the achievable charge or discharge rate. Active materials may be mixed with or applied to the conductive component or network to extend the interface over a greater surface area. Electrochemical interactions may occur at the interface between an active material, an electrolyte, and an electronically conductive material.

The electronically conductive substrate may be impermeable, preventing leakage or short circuiting. In some arrangements, one or more porous electrodes may be maintained in contact with an electronically conductive, non-porous substrate, as shown in FIGS. 1-4. This arrangement may allow for electronic transfer among an external circuit and the electrode.

As defined herein, “foam” shall mean solid-phase porous structures, or solid-phase networks having pores. Foams may contain voids that may be filled with gas or vacuum, or may be partially or entirely filled with gas, liquid, paste, particles, any other suitable material or any combination thereof. Porosity describes the fraction of foam volume occupied by voids. Foams may contain more than one solid component and may include composites of different materials. Open cell foams refer to foams in which the pores are interconnected. Open cell foams may allow for molecular transport of reactants, products, electrolytes, ions or other compounds throughout the foam and between the foam and the surrounding environment. Closed cell foams include pores that are sealed off from one another, effectively preventing transport of compounds throughout the foam. In the following discussion, the term foam will be understood to refer to open cell foams.

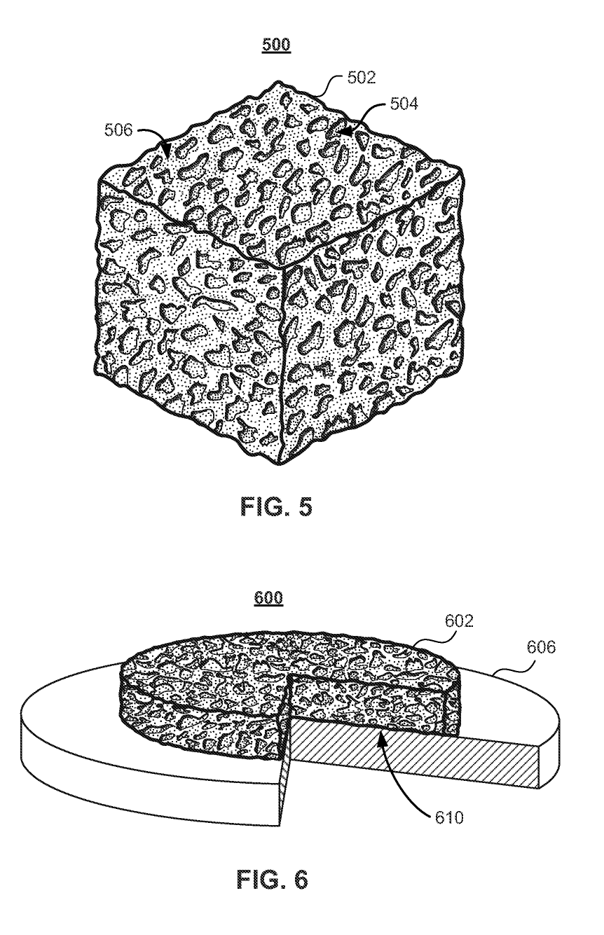

FIG. 5 shows a cubic section of illustrative foam 500 in accordance with some embodiments of the present invention. Solid phase component 502 may have a plurality of pores 504 interspersed throughout, thereby imparting porosity. Foam 500 may include a plurality of pores 506 having a relatively smaller spatial scale than pores 504. Pores 506 may be characteristic of electronically conductive particles used to create foam 500. Pores 504 may form a substantially interconnected network throughout the foam which may allow transport processes to occur. Pores 504 may have any suitable shape or size distribution. Pores 504 may have shape and size characteristics, for example, of a precursor material (e.g., polymer particles). The porosity of foam 500 may have any suitable value between 0 and 1, with larger porosity being associated with values nearer to 1. Larger values of porosity may correspond to larger values of surface area of the foam. In some embodiments, foam 500 may include one or more electronically conductive components (e.g., metals), one or more active materials (e.g., Ni(OH)₂), one or more binders, any other suitable materials or any combination thereof.

FIG. 6 shows an illustrative electrode structure 600 with a cutaway section in accordance with some embodiments of the present invention. Electrode structure 600 may include foam 602 and substrate 606. Foam 602 and substrate 606 may share interface 610 as a plane of contact. Interface 610 represents the plane or path in space where at least two components, materials or any suitable combination thereof may meet in contact. The term “interface” as used herein shall refer to the substantially planar area of contact between a slurry and a substrate, a solid foam and a substrate, any two suitable components, any suitable component and a non-solid phase, or any other plane of contact between two distinct materials or components. Although shown as a planar disk geometry, electrode structure 600 may have any suitable shape, curvature (e.g., dome shaped), thickness (of either layer), relative size (among substrate and foam), relative thickness (among substrate and foam), any other property or any suitable combination thereof. Foam 602 and substrate 606 may have any suitable three dimensional shape, having a cross section that may be substantially circular, square, rectangular, triangular, hexagonal, elliptical, and any other suitable cross section, or combinations of shapes thereof. For example, in some embodiments, foam 602 may be a parallelepiped with square cross section and substrate 606 may be cylindrical. Foam 602 may include one or more electronically conductive components (e.g., metals), one or more active materials (e.g., Ni(OH)₂), one or more binders, any other suitable materials or any combination thereof. In some embodiments, active materials may be introduced to foam 602 following assembly or creation of structure 600.

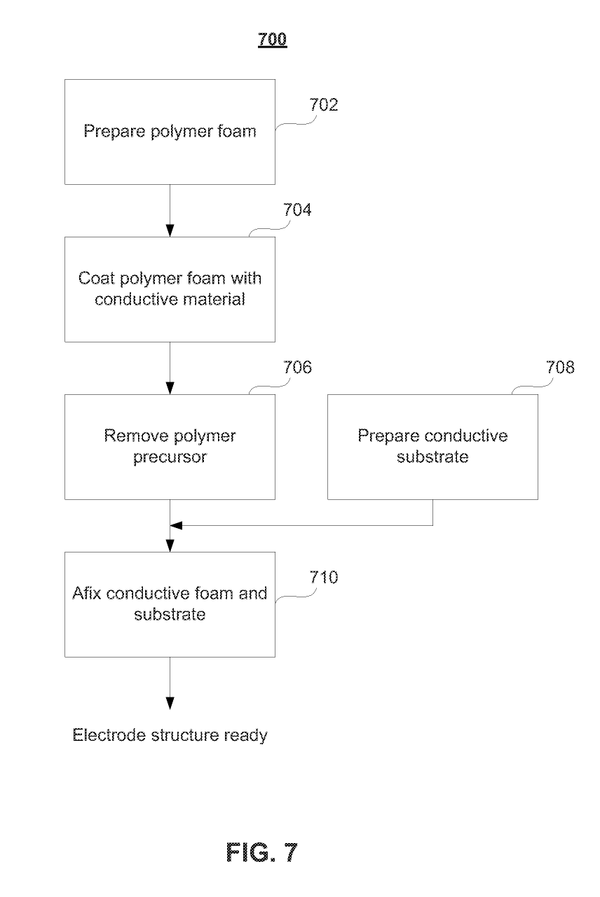

Some exemplary techniques for creating electronically conductive foams in contact with electronically conductive substrates will be discussed in the context of illustrative FIGS. 7-10 in accordance with some embodiments of the present invention.

FIG. 7 shows illustrative flow diagram 700 for creating an electrode structure in accordance with some embodiments of the present invention. Process step 702 may include preparing a precursor material such as, for example, a polymer foam. In some embodiments, process step 702 may include making the polymer foam by use of, for example, blowing agents. It will be understood that any suitable technique or combination of techniques may be used to make a polymer foam. Process step 702 may include cleaning the polymer foam, etching the polymer foam, adjusting the size or shape of the polymer foam (e.g., cutting, grinding, splitting, drilling, machining), treating the polymer to accept an electrical charge, electrically charging the polymer, any other suitable preparation technique or combinations thereof. The polymer foam may be made of carbon based polymers including but not limited to polyurethane, polyethylene, polypropylene, polyvinyl chloride, polystyrene, nylon, polyester, acrylic, polycarbonate, any other suitable polymer or combination thereof, and any suitable additives. The polymer material may substantially maintain its shape characteristic of solid materials. The polymer material may undergo pyrolysis or carbonization at elevated temperature.

The polymer foam may be plated or otherwise coated with an electronically conductive material at process step 704. The conductive coating may be any suitable type of metal (e.g., nickel), any other suitable electronically conductive material or any suitable combination thereof. Process step 804 may include electroplating, electro-less plating, chemical vapor deposition (CVD), physical vapor deposition (PVD), any other suitable plating or coating technique or any suitable combination thereof. In some embodiments, performance of processes 702 and 704 may result in a composite foam with an electronically conductive component or coating material. In some embodiments, active electrode materials may be added to the composite foam during process 704.

The polymer precursor may be removed, as shown by process 706 in FIG. 7, following coating process 704. Process 706 may include increasing the temperature of the coated foam while maintaining the foam in a reducing (e.g., forming gas, hydrogen, humidified hydrogen, diluted hydrogen) or substantially inert (e.g., diatomic nitrogen, argon, helium) environment. Increased temperature in the absence of substantial oxygen or oxygen containing compounds may induce thermal decomposition of organic material (e.g., pyrolysis, carbonization) of the polymer component. The polymer component may decompose into lighter compounds and vaporize, desorb, or otherwise leave the remaining components of the solid foam and enter the gas phase. The polymer may also decompose into solid, carbon-rich compounds or residues which may remain in the solid foam. Process 706 may include processes that cause some portion or substantially all of the polymer component to decompose, carbonize, enter the gas phase, or any combination thereof. Process 706 may remove substantially all of the polymer component and associated decomposition products. In some embodiments, process step 706 may include increasing the temperature to over 300 degrees Celsius in any suitable environment. Process step 706 may also include sintering or otherwise processing the remaining electronically conductive foam at the same or different elevated temperature, for example, to increase conductivity, connectivity, durability, other suitable property or any combination thereof, of the foam.

At step 708 shown in FIG. 7, an electronically conductive, impermeable substrate may be prepared. In some embodiments, the substrate may be larger than the metal foam in some dimension such as, for example, a bi-polar or mono-polar plate. In some embodiments, the substrate may be relatively smaller than the foam in some dimension such as, for example, embodiments where the substrate may be one or more tabs. The substrate may be formed of any suitable electronically conductive and impermeable material. The substrate may be a flat plate of any shape (e.g., disk), curved plate of any shape (e.g., dome), a thin foil, or any other suitable shape having any suitable cross-section. The substrate may include one or more components (e.g., composites). Process step 708 may include preparation steps such as cleaning the substrate, adjusting the surface finish of the substrate (e.g., polishing, roughening), etching the substrate, adjusting the size or shape of the substrate (e.g., cutting, grinding, splitting, drilling, machining), any other suitable preparation steps or any suitable combination thereof.

At process step 710 shown in FIG. 7, the electronically conductive substrate and the electronically conductive foam may be affixed together. The substrate and foam may be placed in contact, forming an interface between the foam and one or more surfaces of the substrate. In some embodiments, more than one foam may be placed in contact with a particular substrate or tab at process step 710. In some embodiments, more than one substrate or tab may be placed in contact with a particular foam at process step 710. The substrate and foam may be maintained in contact by mechanical clamping, bonding, spot welding, maintaining orientation by placing substrate and foam in a vertical manner such that gravity causes a nonzero normal force between the components, any other suitable adherence technique or any combination thereof. Process step 710 may include bonding, sintering, soldering, welding, any other suitable technique or any combination thereof to create a durable adherence between the one or more substrates and the one or more foams. Following process step 810, the electrode structure may be ready for assembly in a device (e.g., ESD), addition of active materials, sintering, any other further processing steps or suitable combination thereof.

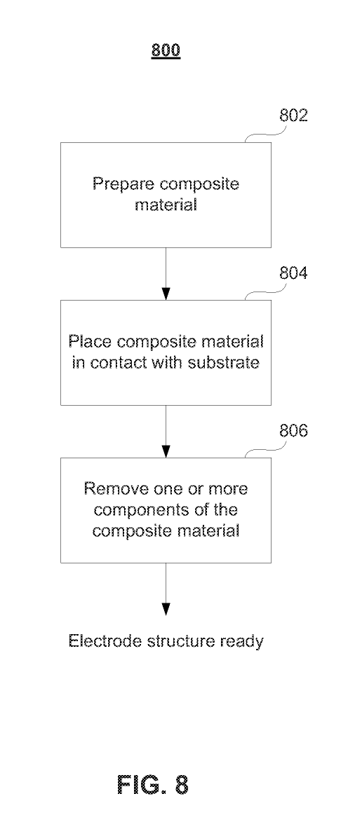

FIG. 8 shows illustrative flow diagram 800 for creating an electrode structure in accordance with some embodiments of the present invention. Process step 802 may include preparing a composite material which includes one or more components. The composite material may include components such as polymer particles, polymer foam, binders, electronically conductive particles (e.g., metal particles), carbon particles, active materials, coated materials, liquid (e.g., water, organic solvent), any other suitable components or any suitable combinations thereof. The composite material may be in the form of a slurry, paste, solid foam, solid particles, coated solid components (e.g., coated polymer foam), any other suitable form or combination thereof. Process step 802 may include mixing, blending, stirring, sonicating (i.e., applying sound waves to agitate particles), ball milling, grinding, sizing (e.g., sieving), drying, coating (e.g., electroplating, electro-less plating, CVD, PVD), sintering, any other suitable process to prepare the composite material or any suitable combination thereof.

At process step 804 shown in FIG. 8, the composite material may be placed in contact with one or more substrates. The composite material may be placed in one or more contiguous layers on one or more surfaces of the substrate. For example, composite material may be applied to both opposing surfaces of a flat substrate as separate layers (e.g., BPU). In some embodiments, different composite materials (e.g., different composition) may be placed in contact with a single substrate (e.g., BPU). In some embodiments, process step 804 may include applying a slurry composite material to the substrate, for example by doctor-blading, spin coating, screen printing, any other suitable slurry application technique or any suitable combination thereof. In some embodiments, process step 804 may include placing and maintaining a solid composite material in contact with the substrate including techniques such as, for example, mechanically clamping of a solid composite material to the substrate, bonding of a solid composite material to the substrate, pressing of a solid composite material to the substrate, maintaining orientation by placing one component on another in a vertical manner such that gravity causes a nonzero normal force between the components, any other suitable adherence technique or any suitable combination thereof.

At process step 806 shown in FIG. 8, one or more electronically nonconductive components of the composite material in contact with the substrate may be removed. Process step 806 may include increasing the temperature of the composite material and the substrate while maintaining the composite material and substrate in a reducing (e.g., forming gas, hydrogen, humidified hydrogen, diluted hydrogen) or substantially inert (e.g., diatomic nitrogen, argon, helium) environment. Process step 806 may also include chemical leaching, dissolving, any other suitable low-temperature (e.g., less than 100 degrees centigrade) technique or combination thereof. In some examples, process step 806 may correspond to process step 706 shown in FIG. 7. The resulting structure following process step 806 may include a porous electronically conducting solid in contact with a non-porous electronically conducting substrate. In some embodiments, the resulting structure following process step 806 may include active materials, binders, any other suitable materials or components, or any suitable combination thereof. Following process step 806, the electrode structure may be ready for assembly in a device such as an ESD, addition of active materials, coating with an electronically conductive material, sintering, any other further processing or assembly steps or any suitable combinations thereof.

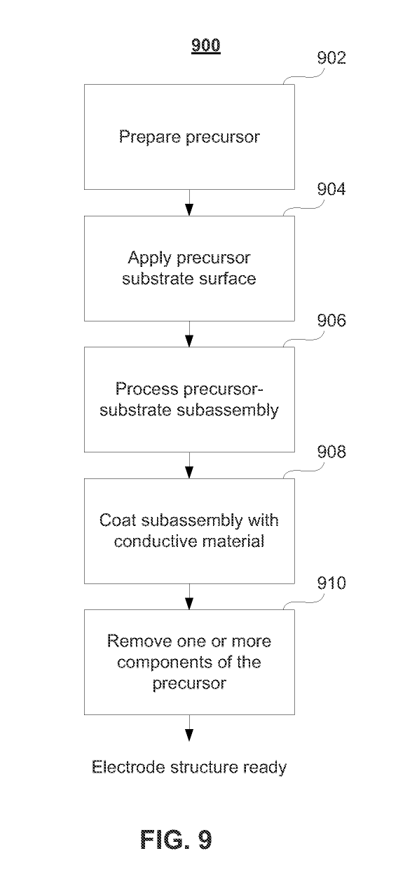

FIG. 9 shows illustrative flow diagram 900 for creating an electrode structure in accordance with some embodiments of the present invention. At process step 902 shown in FIG. 9, a precursor material, such as, for example, a polymer foam or a polymer slurry, may be prepared. The precursor material may be solid, liquid, or any suitable combination (e.g., slurry, colloid, suspension). In some embodiments, the precursor may be polymer slurry and may include polymer particles, one or more liquid agents (e.g., organic solvent, water, alcohol), one or more binders, active materials, carbon (e.g., graphite), any other suitable materials or any suitable combination thereof. The polymer particles may have any suitable shape or size distribution. The polymer particles may include any suitable type of polymer or combination of polymers. Process step 902 may include mixing, blending, stirring, sonicating, ball milling, grinding, sizing (e.g., sieving), drying, any other suitable preparation steps or any suitable combination thereof. In some embodiments, the precursor may be a polymer foam, created from any type of suitable polymer or combination thereof. In some embodiments, process step 902 may include cleaning the polymer foam, etching the polymer foam, adjusting the size or shape of the polymer foam (e.g., cutting, grinding, splitting, drilling, machining), treating the polymer to accept an electrical charge, electrically charging the polymer, any other suitable preparation technique or combinations thereof.

At process step 904 shown in FIG. 9, the precursor material of process step 902 may be applied to one or more surfaces of a suitable substrate. In some embodiments, process step 904 may include applying a slurry by doctor-blading, spin coating, screen printing, any other suitable slurry application technique or any suitable combination thereof. In some embodiments one or more molds of any suitable shape may be used to maintain the slurry of process step 902 in a particular shape. For example, a cylindrical mold in contact with the substrate may be used to maintain the slurry of process step 902 in a cylindrical shape while preventing the slurry of process step 902 from flowing or otherwise deforming. In some embodiments, the mold may be removed at any suitable process step following application of the slurry to the substrate. In some embodiments, process step 904 may include mechanically clamping or bonding a solid precursor material such as, for example, a polymer foam to the substrate. Any suitable adherence technique may be used to maintain contact between the solid precursor material and the substrate.

At process step 906 shown in FIG. 9, the precursor material in contact with the substrate may be further processed. In some embodiments, a precursor slurry may be dried (e.g., some fraction or all of one or more liquid components may be removed). Drying process 906 may impart rigidity to the residual components (e.g., remaining slurry components). In some embodiments, drying process 906 may allow for the residual components to maintain shape such that the mold, if used, may be removed. In some embodiments, drying process 906 may impart porosity to the collection of residual components. In some embodiments, drying process 906 may include heating, immersing the substrate and slurry in a prescribed gaseous environment (e.g., heated argon), any other suitable drying process or combination thereof. In some embodiments, process step 906 may include any suitable processing steps for preparing the precursor material for coating with an electronically conductive material. Process step 906 may be skipped in some embodiments, such as, for example, embodiments in which the precursor material is a solid.

At process step 908 shown in FIG. 9, the processed precursor materials in contact with the substrate may be coated with a suitable material. Coating process 908 may include electroplating, electro-less plating, CVD, PVD, any other suitable plating or coating technique or any suitable combination thereof. In some embodiments, active materials may be added to the porous structure as part of (e.g., before or after) coating process 908. The resulting structure following process step 908 may include a porous electronically conducting network (or foam) and a precursor material component in contact with an impermeable electronically conducting substrate.

At process step 910 shown in FIG. 9, one or more components of the precursor material in contact with the substrate may be removed. Process step 910 may include increasing the temperature of the composite material and the substrate while maintaining the composite material and substrate in a reducing (e.g., forming gas, hydrogen, humidified hydrogen, diluted hydrogen) or substantially inert (e.g., diatomic nitrogen, argon, helium) environment. Process step 910 may also include chemical leaching, dissolving, any other suitable low-temperature (e.g., less than 100 degrees centigrade) technique or combination thereof. In some examples, process step 910 may correspond to process step 706 shown in FIG. 7. The resulting structure following process step 910 may include a porous electronically conducting network or foam in contact with an impermeable electronically conducting substrate. In some embodiments, the resulting structure following process step 910 may include active materials, binders, any other suitable materials or components, or any suitable combination thereof. Following process step 910, the electrode structure may be ready for assembly in a device (e.g., ESD), addition of active materials, sintering, any other further processing steps or suitable combination thereof.

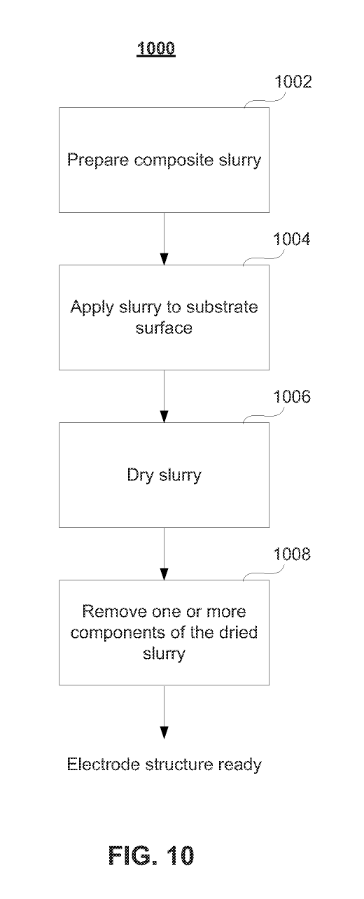

FIG. 10 shows illustrative flow diagram 1000 for creating an electrode structure in accordance with some embodiments of the present invention. At process step 1002 shown in FIG. 10, a slurry may be prepared including electronically conducting particles (e.g., metal particles) and any suitable combination of polymer particles (of any suitable size or shape), one or more liquid agents (e.g., organic solvent, water, alcohol), active materials, binders, carbon (e.g., graphite), or any other suitable materials. The one or more electronically nonconductive components may have any suitable shape or size distribution. In some embodiments, the electronically conducting particles and the electronically nonconductive particles may not necessarily be of the same size and shape. The electronically nonconductive particles may include any suitable type of polymer or combination of polymers. Process step 1002 may include mixing, blending, stirring, sonicating, ball milling, grinding, sizing (e.g., sieving), drying, any other suitable preparation process or any suitable combination thereof.

At process step 1004 shown in FIG. 10, the slurry of process step 1002 may be applied to one or more surfaces of a suitable substrate. Process step 1004 may include doctor-blading, spin coating, screen printing, any other suitable slurry application technique or any suitable combination thereof. In some embodiments one or more molds of any suitable shape may be used to maintain the slurry of process step 1002 in a particular shape on the substrate. For example, a rectangular prism mold in contact with the substrate may be used to maintain the slurry of process step 1002 in a rectangular prism shape while preventing the slurry of process step 1002 from flowing or otherwise deforming.

At process step 1006 shown in FIG. 10, the slurry of process step 1002 in contact with the substrate of process step 1004 may be dried (e.g., some fraction or all of one or more liquid components is removed). Drying process 1006 may impart rigidity to the residual components such as, for example, remaining slurry components. In some embodiments, drying process 1006 may allow for the residual components to maintain shape such that the mold, if used, may be removed. In some embodiments, drying process 906 may impart porosity to the collection of residual components. In some embodiments, drying process 906 may include heating, immersing the substrate of process step 1004 and slurry of process step 1002 in a prescribed gaseous environment (e.g., heated argon), any other suitable drying process or combination thereof.

At process step 1008 shown in FIG. 10, the electronically nonconductive component of the dried slurry residual components in contact with the substrate may be removed. Process step 1008 may include increasing the temperature of the residual components and the substrate of process step 1006 while maintaining the residual components and substrate in a reducing (e.g., forming gas, hydrogen, humidified hydrogen, diluted hydrogen) or substantially inert (e.g., diatomic nitrogen, argon, helium) environment. Process step 1008 may also include chemical leaching, dissolving, any other suitable low-temperature (e.g., less than 100 degrees centigrade) technique or combination thereof. In some examples, process step 1008 may correspond to process step 706 shown in FIG. 7. The resulting structure following process step 1008 may include an electronically conducting foam in contact with an impermeable electronically conducting substrate. In some embodiments, the resulting structure following process step 1008 may include active materials, binders, any other suitable materials or components, or any suitable combination thereof. Following process step 1008, the electrode structure may be ready for assembly in a device (e.g., ESD), addition of active materials, sintering, coating with an electronically conductive material, any other further processing steps or suitable combination thereof.

It will be understood that the steps of flow diagrams 700-1000 are illustrative. Any of the steps of flow diagrams 700-1000 may be modified, omitted, rearranged, combined with other steps of flow diagrams 700-1000, or supplemented with additional steps, without departing from the scope of the present invention.

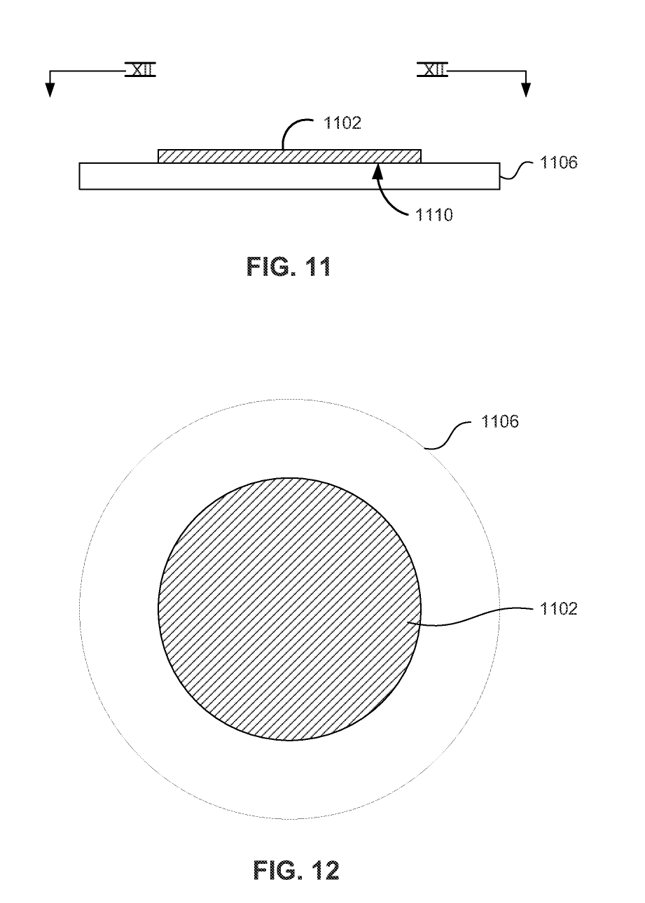

An illustrative process for making an electrode structure in accordance with some embodiments of the present invention will be discussed further in the context of FIGS. 11-15.

FIG. 11 shows an illustrative side elevation view of precursor material 1102 in contact with substrate 1106 in accordance with some embodiments of the present invention. Shown in FIG. 12 is an illustrative top plan view of the elements of FIG. 11, taken from line XII-XII of FIG. 11 in accordance with some embodiments of the present invention. Precursor material 1102 is shown in contact with substrate 1106 at interface 1110. Substrate 1106 and precursor material 1102 may have any suitable shape, cross-section shape, curvature, thickness (of either layer 1106 or 1102), relative size (among substrate and precursor material), relative thickness (among substrate and precursor material), any other property or any suitable combinations thereof. Precursor material 1102 may be any suitable material for forming an electrode structure, and may include polymer foams, composite materials (e.g., the composite material discussed in flow diagram 800 of FIG. 8), dried polymer slurries (e.g., the dried slurry discussed in process step 906 of FIG. 9), binders, any other suitable materials or any suitable combinations thereof.

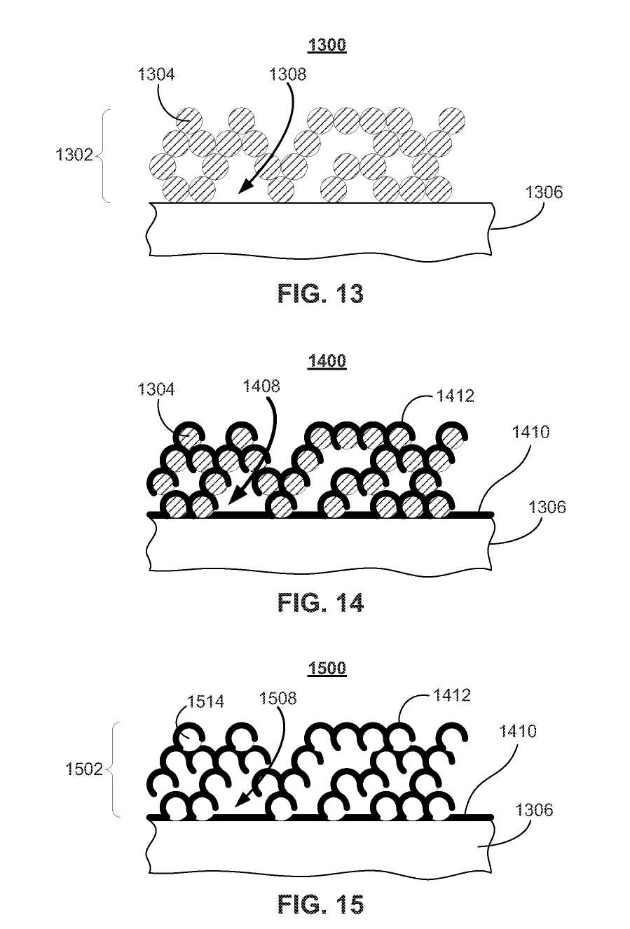

FIG. 13 shows an illustrative partial cross-sectional view of interface region 1300 between precursor material 1302 and substrate 1306 in accordance with some embodiments of the present invention. Interface region 1300 shown in FIG. 13 may correspond to or represent a schematic close-up view of interface 1110 shown in FIG. 11. In some embodiments, precursor material 1302 may include solid component 1304 and pore network 1308. Pore network 1308 may include pores of any suitable size and/or shape. Although shown illustratively in FIG. 13 as being made of particles having circular cross-section, precursor material 1302 may have any suitable cross-section profile that includes a solid phase and a pore network (e.g., any suitable porous solid). It will be understood that an illustrative, schematic two dimensional section representation of a three dimensional porous solid, such as that shown by FIG. 13, may not show some connectivity of the solid (or pores) but that connectivity may nonetheless exist.

FIG. 14 shows an illustrative partial cross-sectional view of interface region 1400 between precursor material 1302 and substrate 1306 of FIG. 13, coated with electronically conductive material 1412 in accordance with some embodiments of the present invention. Interface region 1400 shows the interface between precursor material 1302 and substrate 1306 of FIG. 13 following a coating process (e.g., process step 908 of FIG. 9) of interface region 1300. Coating material 1412 may be applied to some or all of the surfaces of precursor material 1302, forming coated precursor material 1402. In some embodiments, the coating process may also include coating substrate 1306 with coating material 1410. In some embodiments, coating material 1410 and coating material 1412 may be in contact, for example, allowing electronic conduction. Coated precursor material 1402 may include pore network 1408, which may impart porosity. Pore network 1408 may correspond substantially with pore network 1308 prior to the coating process.

FIG. 15 shows an illustrative partial cross-sectional view of interface region 1500 between electronically conductive network 1502 and substrate 1306 of FIG. 14 in accordance with some embodiments of the present invention. Interface region 1500 includes an illustrative interface between precursor material 1402 and substrate 1306 of FIG. 14 following removal of one or more components of coated precursor material 1402, such as, for example, described by process step 910 of FIG. 9. In some embodiments, electronically conductive network 1502 may substantially correspond to coating 1412. In some embodiments, electronically conductive network 1502 may include pore network 1508 which may arise from pore network 1408. In some embodiments, pore network 1514 may arise from removal of one or more suitable components of coated precursor material 1402. Pore network 1514 may have properties (e.g., pore size, interconnectivity) that differ from pore network 1508. In some embodiments, pore network 1508 and pore network 1514 may form a single pore network following removal of one or more components of coated precursor material 1402. Although FIG. 15 shows complete removal of precursor material 1302, it will be understood that one or more components of precursor material 1302 may not be removed. It will also be understood that electronically conductive network 1502 may include one or more components, either electronically conducting or otherwise, remaining from precursor material 1302. The electrode structure containing interface region 1500 may be plated or otherwise coated with an electronically conductive material. The electrode structure containing interface region 1500 may be sintered during or after removal of one or more suitable components of coated precursor material 1402.

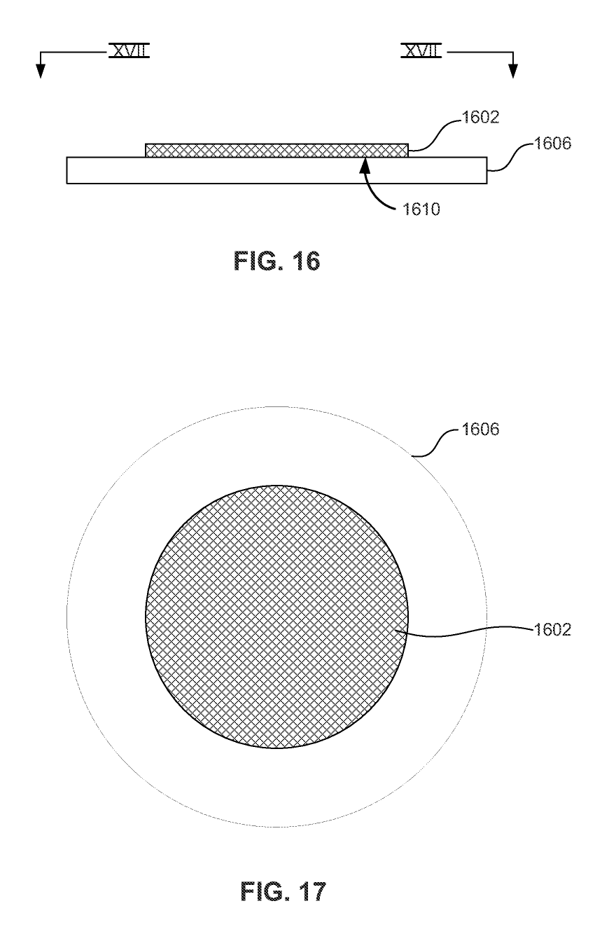

An illustrative process for making an electrode structure in accordance with some embodiments of the present invention will be discussed further in the context of FIGS. 16-21.

FIG. 16 shows an illustrative side elevation view of composite material 1602 in contact with substrate 1606 in accordance with some embodiments of the present invention. Shown in FIG. 17 is an illustrative top plan view of the elements of FIG. 16, taken from line XVII-XVII of FIG. 16 in accordance with some embodiments of the present invention. Composite material 1602 is shown in contact with substrate 1606 at interface 1610. Substrate 1606 and composite material 1602 may have any suitable shape, cross-section shape, curvature, thickness (of either layer 1606 and 1602), relative size (among substrate and composite material), relative thickness (among substrate and composite material), any other property or any suitable combinations thereof. In some embodiments, composite material 1602 may include the dried slurry discussed above in process step 1006 of FIG. 10. Composite material 1602 may be any suitable material for forming an electrode structure and may include an electronically conductive material, and one or more of a polymer foam, electronically nonconductive particles (e.g., polymer particles), composite material (e.g., the composite material discussed in process step 802 of FIG. 8), binder, any other suitable material, or any suitable combination thereof.

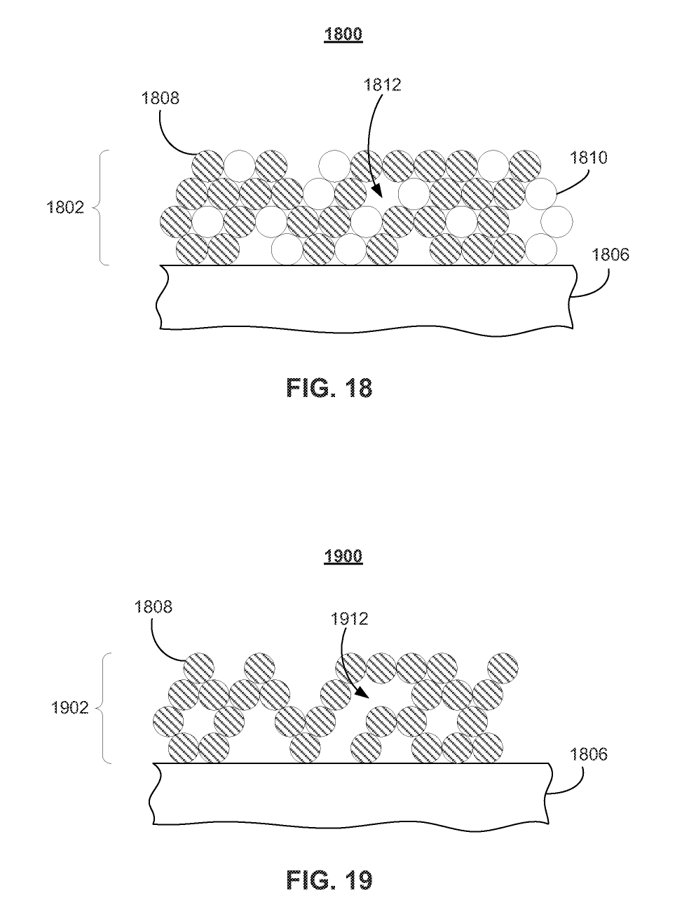

FIG. 18 shows an illustrative partial cross-sectional view of interface region 1800 between composite material 1802 and substrate 1806 in accordance with some embodiments of the present invention. Interface region 1800 shown in FIG. 18 may correspond to or represent a schematic close-up view of interface 1610 shown in FIG. 16. In some embodiments, composite material 1802 may include solid components 1808 and 1810, of which one or both may be electronically conductive, and pore network 1812. Pore network 1812 may include pores of any suitable size and/or shape. Although shown illustratively in FIG. 18 as being made of particles having circular cross-section, composite material 1802 may have any suitable cross-section profile including a solid phase and a pore network (e.g., any suitable porous solid). Composite material 1802 may include any number of components greater than one, in any suitable combination. It will be understood that an illustrative, schematic two dimensional section representation of a three dimensional porous solid, such as that shown by FIG. 18, may not show some connectivity of the solid (or pores) but that connectivity may nonetheless exist.

FIG. 19 shows an illustrative partial cross-sectional view of interface region 1900 between electronically conductive foam 1902 and substrate 1806 in accordance with some embodiments of the present invention. In some embodiments, interface region 1900 shows an interface between composite material 1802 and substrate 1806 of FIG. 18 following removal of one or more components of composite material 1802, such as, for example, described by process step 806 of FIG. 8 or step 1008 of FIG. 10. In some embodiments, electronically conductive network 1902 may correspond to one or more components of composite material 1802. In some embodiments, electronically conductive network 1902 may include pore network 1912. In some embodiments, pore network 1912 may arise in part from removal of one or more components of composite material 1802. It will be understood that one or more components of composite material 1802 may not be removed. It will also be understood that electronically conductive network 1902 may include one or more components, either electronically conducting or otherwise, remaining from composite material 1802. In some embodiments, the electrode structure containing interface region 1900 may be sintered during or after removal of one or more suitable components of composite material 1802.

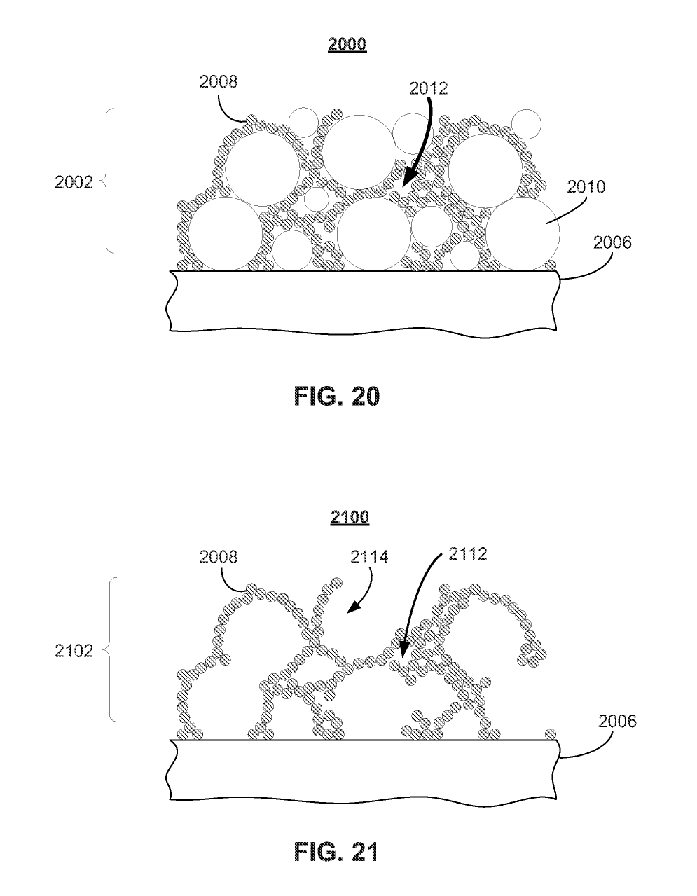

FIG. 20 shows an illustrative partial cross-sectional view of interface region 2000 between composite material 2002 and substrate 2006 in accordance with some embodiments of the present invention. Interface region 2000 shown in FIG. 20 may correspond to or represent a schematic close-up view of interface 1610 shown in FIG. 16. In some embodiments, composite material 2002 may include solid components 2008 and 2010, of which one or both may be electronically conductive, and pore network 2012. Solid components 2008 and 2010 may have any suitable size distributions and/or shape distributions. In some embodiments, solid components 2008 and 2010 may have different size distributions and/or shape distributions. Pore network 2012 may include pores of any suitable size and/or shape. Although shown illustratively in FIG. 20 as being made of particles having circular cross-section, composite material 2002 may have any suitable cross-section profile including a solid phase and a pore network (e.g., any suitable porous solid). Composite material 2002 may include any number of components greater than one, in any suitable combination. It will be understood that an illustrative, schematic two dimensional section representation of a three dimensional porous solid, such as that shown by FIG. 20, may not show some connectivity of the solid (or pores) but that connectivity may nonetheless exist.

FIG. 21 shows an illustrative partial cross-sectional view of interface region 2100 between electronically conductive foam 2102 and substrate 2006 in accordance with some embodiments of the present invention. Interface region 2100 shows an illustrative interface between composite material 2002 and substrate 2006 of FIG. 21 following removal of one or more components of composite material 2002, such as, for example, described by process step 806 of FIG. 8 or step 1008 of FIG. 10. In some embodiments, electronically conductive foam 2102 may correspond to one or more components of composite material 2002. In some embodiments, electronically conductive foam 2102 may include pore network 2112 and pore network 2114. In some embodiments, pore network 2112 may correspond to pore network 2012. In some embodiments, pore network 2114 may arise in part from removal of one or more components of composite material 2002. In some embodiments, pore network 2112 and 2114 may form a single pore network. It will be understood that one or more components of composite material 2002 may not be removed. It will also be understood that electronically conductive foam 2102 may include one or more components, either electronically conducting or otherwise, remaining from composite material 2002.

It will be understood that the foregoing is only illustrative of the principles of the invention, and that various modifications may be made by those skilled in the art without departing from the scope and spirit of the invention. It will also be understood that various directional and orientational terms such as “horizontal” and “vertical,” “top” and “bottom” and “side,” “length” and “width” and “height” and “thickness,” “inner” and “outer,” “internal” and “external,” and the like are used herein only for convenience, and that no fixed or absolute directional or orientational limitations are intended by the use of these words. For example, the devices of this invention, as well as their individual components, may have any desired orientation. If reoriented, different directional or orientational terms may need to be used in their description, but that will not alter their fundamental nature as within the scope and spirit of this invention. Those skilled in the art will appreciate that the invention may be practiced by other than the described embodiments, which are presented for purposes of illustration rather than of limitation, and the invention is limited only by the claims that follow.

What is claimed is:

1. A method for forming an electrode structure, the method comprising:
placing in contact a precursor material and an electronically conductive substrate, wherein an interface exists between a surface of the substrate and the precursor material;
introducing an electronically conductive material to the precursor material to form an electronically conductive network throughout the volume of the precursor material, wherein contact is maintained between the precursor material and the substrate; and
removing substantially all of the precursor material to form a corresponding electronically conductive foam in contact with the substrate.

2. The method of claim 1, wherein the precursor material comprises a polymer foam.

3. The method of claim 1, wherein placing in contact a precursor material and an electronically conductive substrate further comprises:
combining a plurality of first particles and a liquid agent to form a slurry;
forming at least one contiguous layer of the slurry on the electronically conductive substrate; and
removing substantially all of the liquid agent from the at least one contiguous layer of the slurry to leave the precursor material, wherein the precursor material remains in contact with the substrate.

4. The method of claim 1, wherein the electrode structure is configured for use in an energy storage device.

5. The method of claim 1, further comprising introducing an active material to the electrode structure.

6. The method of claim 1, wherein introducing the electronically conductive material to the precursor material further comprises introducing the electronically conductive material to at least one surface of the substrate.

7. The method of claim 1, wherein the electronically conductive foam comprises a metal.

8. The method of claim 7, wherein the metal is selected from the group consisting of nickel, steel, aluminum, gold, silver, and copper.

9. The method of claim 1, wherein the electronically conductive substrate comprises a metal.

10. The method of claim 1, wherein the electronically conductive substrate is selected from the group consisting of nickel, aluminum foil, stainless steel foil, nickel plated steel, nickel plated copper, nickel plated aluminum, gold, silver, and copper.

11. The method of claim 1, wherein the substrate has flat plate geometry.

12. The method of claim 1, wherein the substrate has curved plate geometry.

13. The method of claim 1, wherein removing the precursor material further comprises increasing the temperature of the electrode structure in a prescribed gaseous environment.

14. The method of claim 1, wherein placing in contact the precursor material and the substrate comprises mechanically clamping the precursor material to the substrate.

15. The method of claim 1, wherein placing in contact the precursor material and the substrate comprises bonding the precursor material to the substrate.

16. The method of claim 1, further comprising sintering the electronically conductive foam and the substrate.

17. A method for forming an electrode structure, the method comprising:
combining a plurality of first particles, a plurality of second particles, and a liquid agent to form a slurry;
forming at least one contiguous layer of the slurry on a surface of an electronically conductive substrate;
removing substantially all of the liquid agent from the at least one contiguous layer of the slurry to leave a solid composite material, wherein the solid composite material remains in contact with the surface of the substrate; and
removing substantially all of the plurality of first particles from the composite material, wherein the remaining plurality of second particles form a corresponding electronically conductive foam in contact with the substrate.

18. The method of claim 17, wherein the plurality of first particles comprises a plurality of polymer particles.

19. The method of claim 17, wherein the electrode structure is configured for use in an energy storage device.

20. The method of claim 17, further comprising introducing an active material to the electrode structure.

21. The method of claim 17, further comprising introducing an electronically conductive material to the electrode structure.

22. The method of claim 17, wherein the electronically conductive foam comprises a metal.

23. The method of claim 22, wherein the metal is selected from the group consisting of nickel, steel, aluminum, gold, silver, and copper.

24. The method of claim 17, wherein the electronically conductive substrate comprises a metal.

25. The method of claim 17, wherein the electronically conductive substrate is selected from the group consisting of nickel, aluminum foil, stainless steel foil, nickel plated steel, nickel plated copper, nickel plated aluminum, gold, silver, and copper.

26. The method of claim 17, wherein the electronically conductive substrate has flat plate geometry.

27. The method of claim 17, wherein the electronically conductive substrate has curved plate geometry.

28. The method of claim 17, wherein removing the plurality of first particles further comprises increasing the temperature of the electrode structure in a prescribed gaseous environment.

29. The method of claim 17, further comprising sintering the electronically conductive foam and the electronically conductive substrate.

30. An electrode structure formed by the method comprising:
placing in contact a surface of an electronically conductive substrate with a composite material, wherein the composite material comprises:
at least one electronically conductive component, and
at least one electronically nonconductive component; and
removing substantially all of the electronically nonconductive component from the composite material, wherein the remaining at least one electronically conductive component forms an electronically conductive foam in contact with the substrate.

31. The electrode structure of claim 30, wherein the composite material comprises a polymer.

32. The electrode structure of claim 30, wherein the electrode structure is configured for use in an energy storage device.

33. The electrode structure of claim 30, further comprising introducing an active material to the electrode structure.

34. The electrode structure of claim 30, further comprising introducing an electronically conductive material to the electrode structure.

35. The electrode structure of claim 30, wherein the electronically conductive foam comprises a metal.

36. The electrode structure of claim 35, wherein the metal is selected from the group consisting of nickel, steel, aluminum, gold, silver, and copper.

37. The method of claim 30, wherein the electronically conductive substrate comprises a metal.

38. The electrode structure of claim 30, wherein the electronically conductive substrate is selected from the group consisting of nickel, aluminum foil, stainless steel foil, stainless steel, nickel plated steel, nickel plated copper, nickel plated aluminum, gold, silver, and copper.

39. The electrode structure of claim 30, wherein the substrate has flat plate geometry.

40. The electrode structure of claim 30, wherein the substrate has curved plate geometry.

41. The electrode structure of claim 30, wherein the electronically nonconductive component is removed by increasing the temperature of the electrode structure in a prescribed gaseous environment.

42. The electrode structure of claim 30, wherein the composite material and the substrate are mechanically clamped to maintain contact.

43. The electrode structure of claim 30, wherein the composite material and the substrate are bonded to maintain contact.

44. The electrode structure of claim 30, further comprising sintering the electronically conductive foam and the substrate.
